(19) United States
(12) Patent Application Publication
(10) Pub. No.: US 2014/0334361 A1
(43) Pub. Date: Nov. 13, 2014

(54) APPARATUS FOR COMMUNICATION USING SIMPLEX ANTENNAS

(71) Applicant: Motorola Mobility LLC, Libertyville, IL (US)

(72) Inventors: Thomas D. Nagode, Vernon HIlls, IL (US); Armin W. Klomsdorf, Chicago, IL (US); Hugh K. Smith, Palatine, IL (US)

(73) Assignee: Motorola Mobility LLC, Libertyville, IL (US)

(21) Appl. No.: 13/892,615

(22) Filed: May 13, 2013

(51) Int. Cl. H04L 5/14; H04B 1/38

(52) U.S. Cl. CPC H04L 5/14; H04B 1/38
USPC 370/281; 370/295

(57) ABSTRACT

An apparatus comprises a duplexer having a transmit port, a receive port, and an antenna port. A transmitter is coupled to the antenna port of the duplexer. A transmit antenna is coupled to the transmit port of the duplexer. The apparatus may comprise a matching termination coupled to the receiver port.

### FIELD OF THE INVENTION

The present invention relates generally to radio communications, and more specifically to apparatus that optimizes frequency division duplex radio communications.

### BACKGROUND

Frequency division duplexing has been used in radio communication systems for many years to allow the simultaneous transmission and reception of radio signals by a radio transceiver. In such systems, two frequency bands are typically used, one for transmission signals and one for reception signals. The frequency bands are separated but filtering is typically needed to prevent undesirable energy that is generated by internal and external sources and that is within the frequency band of the receiver from combining with desirable energy being intercepted by the receive antenna, thereby degrading the reception of the desirable signal. One filtering configuration that is in common use in frequency division duplex systems uses a three port passive electronic component that has a receive port coupled to a receiver input, a transmit port coupled to a transmitter output, and an antenna port coupled to a single antenna that is used for the simultaneous reception and transmission of radio signals coupled in a first signal path between the antenna and receiver and a second signal path between the antenna and the transmitter amplifier. This three port device is commonly called a duplexer or a diplexer. This filtering configuration is commonly found in portable communication devices operating in cellular systems such as those that use well known air-interface standards such as LTE (Long Term Evolution) and W-CDMA (Wideband Code Division Multiple Access), as well as other FDD communication systems.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments that include the aspects of the claimed invention, and explain various principles and advantages of those embodiments.

FIG. 1 is a functional block diagram of a device that includes a transmitter, in accordance with certain embodiments.

FIG. 2 is an electrical block diagram of portions of the device of FIG. 1, in accordance with certain embodiments in which the device is a prior art device designed for use in a frequency duplex communication system.

FIGS. 3-5 are electrical block diagrams of portions of devices in accordance with certain embodiments in which the devices have novel features.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the following embodiments, it should be observed that the embodiments reside primarily in apparatus related to frequency transceivers or transmitters using antenna(s) and a duplexer. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

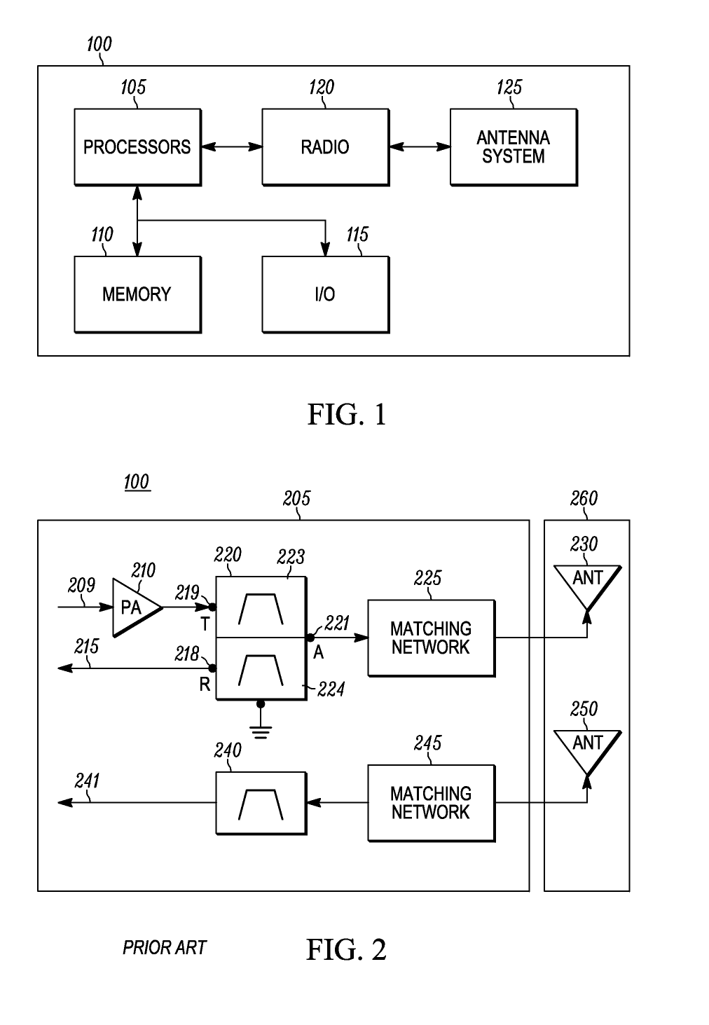

Referring to FIG. 1, a functional block diagram of a device 100 is shown that includes a transmitter, in accordance with certain embodiments. The device 100 includes one or more processors 105, each of which may include such sub-functions as central processing units, cache memory, instruction decoders, just to name a few. The processors execute program instructions which could be located within the processors in the form of programmable read only memory, or may located in a memory 110 to which the processors 105 are bi-directionally coupled. The processors 105 may include input/output interface circuitry and may be coupled to separate input/output interface circuitry 115, such as buttons, audio input/output, and a display. The processors 105 are further coupled to a radio function 120. In some embodiments, the radio function 120 is a transmit only function, while in others it is a receive-transmit function. The radio function 120 is coupled to a radio antenna system 125. In some embodiments, the processors 105 may be coupled to the radio function 120 through the input/output function 115. The radio function 120 may comprise one or more processors and memory, in addition to circuits that are unique to radio functionality. The device 100 may be a personal communication device such as a cell phone, a tablet, or a personal computer, or may be any other type of radio transmitter operating in a radio network. An example of the device 100 which includes only a transmit function is a device such as a sensor device that only reports information. Embodiments having no receiver may operate in a one way (uplink) radio communication system, or a two way system that operates in a duplex manner (time and/or frequency division) or in a simplex manner and which has an air protocol designed to allow a one way device 100. In some embodiments, the device 100 is an LTE (Long Term Evolution) UE (user equipment that operates in a 3GPP (3^{rd} Generation Partnership Project) communication system and operates according to the LTE air protocol specified by 3GPP documents, which can operate in a frequency division duplex mode. In other embodiments, the device operates according to air protocol standards for a W-CDMA communication system, which also which can operate in a frequency division duplex mode. The transmit frequency range and receive frequency range in LTE and W-CDMA systems do not overlap. The transmit frequency range and receive frequency range in some FDD communication systems not only do not overlap, there may a significant frequency interval between them that is not within either frequency band.

Referring to FIG. 2, an electrical block diagram of portions of the device 100 is shown, in accordance with certain embodiments in which the device 100 is a prior art device designed for use in a frequency duplex communication system in which there are (at least) one receive frequency band and one transmit frequency band that are separated and which are used simultaneously for uplink (inbound) and downlink (outbound) communication signals. A portion 205 of the receiver-transmitter function of device 100 and an antenna system 260 which represents the antenna system 125 of device 100 are shown for these prior art embodiments of device 100. Portion 205 comprises a transmitter PA (power amplifier) 210 that accepts a transmit signal 209 and amplifies the transmit signal 209 to a power level selected for a particular transmission. The amplified transmit signal is coupled to a transmit port (T) 219 of a duplexer 220. The amplified transmit signal passes through a transmit filter portion 223 of the duplexer and is coupled to an antenna port (A) 221 of the duplexer. The transmit signal, which is now an amplified and filtered signal, is coupled to a matching network 225, which couples the amplified and filtered transmit signal to a transmit-receive antenna 230. The matching network 225 is typically a low loss network of passive impedances designed to optimize coupling between the transmit-receive antenna and the antenna port 221 of the duplexer. In some embodiments, the matching network may comprise passive impedances that are switched into or out of the network to optimize the coupling during environmental changes that affect the antenna characteristics. In some embodiments, no matching network is used because the impedances of the transmit-receive antenna 221 and antenna port 221 are sufficiently matched.

The transmit-receive antenna 230 also intercepts downlink radio signals and couples them to the matching network 225. The radio signals from the matching network 225 are coupled to the antenna port 221 of the duplexer 220, where they are coupled to both the transmit filter portion 223 and a receive filter portion 224 of the duplexer. The receive filter portion 224 has a passband that accommodates (is approximately the same as) the receive frequency band of the communication system. At the antenna port, the receive filter portion 224 provides significant attenuation (for example, greater than 50 dB) at frequencies within the transmit frequency band, and a high return loss (for example, 15 dB) and little insertion loss (for example, 1.5 dB) for signals within the receive frequency band. At the antenna port the transmit filter portion 223 provides a low return loss (for example, less than 1 dB) to frequencies within the receive frequency band. Therefore, almost all of the radio signal from the matching network 225 is coupled to the receive port (R) 218, with very little undesirable energy included, where it is received by the device 100. The physical configuration of transmit-receive antenna 230 and the electrical matching of the transmit-receive antenna 230 to the matching network 225 optimize the gain of the transmit-receive antenna 230 over both the transmit and receive frequency bands of the communication system.

In certain embodiments, the device 100 may also include an optional diversity receive antenna 250 coupled to a diversity receive matching network 245, the output of which is further coupled to a diversity receive filter 240. In these embodiments, the diversity receive antenna 250 is typically physically configured to be de-correlated with the transmit-receive antenna 230 (either in polarization or spatial aspects, or both), and may have a narrower bandwidth than the transmit-receive antenna 230, because the diversity receive antenna 250 needs to have optimum gain only over the receive frequency band. The antennas 230, 250 form the antenna system 260 of the device 100. Diversity receive antenna 250 intercepts radio signals. Those intercepted radio signals are coupled to the diversity receive filter 240 by the matching network. The diversity receive filter 240 rejects most of the energy of the radio signal outside the receive frequency band of the communication system. The filtered signal 241 is coupled to other portions of the transmitter-receiver of the device 100, which perform a diversity receiving function using the filtered signals 215 and 241. The diversity antenna 250 is described above as providing polarization diversity, but in some devices 100 it may alternatively or additionally provide space diversity that is effective for reducing fading effects. A receive antenna 250 and additional receive antennas may be provided for a multiple input-multiple output (MIMO) receive antenna subsystem. For each such antenna, an optional matching network and a receive filter is provided, such as for diversity receive antenna 250.

Duplexers such as duplexer 220 are very commonly used in prior art devices 100 such as portable cellular communication devices. These duplexers are typically passive devices that are well known to have the return loss characteristics at the antenna port 221 described above, and also provide high isolation between the two filters. For example, the transmit to receive isolation can typically exceed 50 dB. Duplexers are sometimes referred to as diplexers. The receive to transmit isolation is also high, and can typically exceed 45 dB. Thus the duplexer 220 allows for effective separation of the transmit and receive signals for frequency division duplex communication systems. The receive filter portion and transmit filter portion each has a respective passband characteristic; the receive and transmit passband characteristics are non-overlapping, and each falls within (i.e., less than or equal to) a respective receive frequency band and transmit frequency band of a communication system. The transfer characteristics of the receive filter portion between the receive port and antenna port are the same in both directions for passive duplexers. Similarly the transfer characteristics of the transmit filter portion between the transmit port and antenna port are the same in both directions for passive duplexers. This includes such characteristics as gain versus frequency, group delay, and ripple.

In some of the prior art embodiments of the device 100, there is no matching network 225 between the antenna 230 and the duplexer 220 or no diversity receive matching network 245 between the antenna 250 and the diversity receive filter 240 (in those embodiments using a diversity antenna).

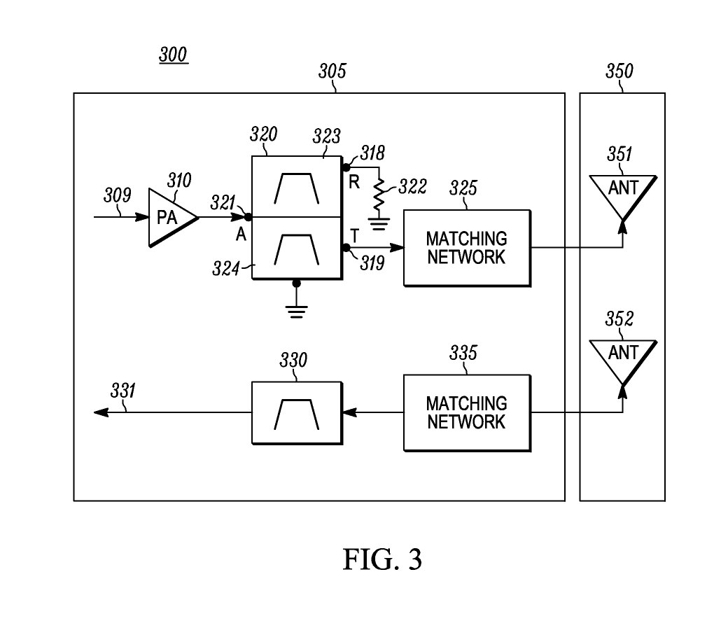

Referring to FIG. 3, an electrical block diagram of portions of a device 300 is shown, in accordance with certain embodiments in which the device 300 has novel features. The novel features are described with reference to FIG. 3 and function in conjunction with portions of device 300 that are substantially the same as the functions of device 100 (FIG. 1) that are not shown (e.g., processors 105, memory 110, and parts of receiver/transmitter 120) in FIG. 3. In particular, a duplexer 320 is coupled in a novel, reverse configuration. The duplexer in some embodiments is identical to duplexer 220 used in prior art portion 205 of device 100, as described with reference to FIG. 2. The device 300 is one that has separate, simplex antennas 351, 352 that are used to provide FDD or non-FDD operation. A portion 306 of the receiver-transmitter function of device 300 and an antenna system 350 of device 300 are shown. Portion 306 comprises a transmitter PA 310 that accepts a transmit signal 309 and amplifies the transmit signal 309 to a power level selected for a particular transmission. The amplified transmit signal is coupled to an antenna port (A) 321 of a duplexer 320. The amplified transmit signal passes through a transmit filter portion 323 of the duplexer and is coupled to a transmit port (T) 319. The transmit signal, which is now an amplified and filtered signal, is coupled from the transmit port 319 to a transmit matching network 325. The transmit matching network 325 optimizes the coupling of a transmit antenna 351 to the transmit port 319 without significantly modifying the signal. In some embodiments the transmit matching network is a fixed passive network. In some embodiments, the transmit matching network is a network including switched passive impedances. In some embodiments the transmit matching network 325 is not used because the impedances of the transmit antenna 321 and transmit port 319 are sufficiently well matched, and the transmit port 319 of the duplexer 320 is directly coupled to the transmit antenna 351. The amplified transmit signal at port 321 is also coupled to receive filter portion 324 of the duplexer 320. The receive filter portion 324 is further coupled to a receive port (R) 318 of the duplexer. A matching termination 322 is also coupled to the receive port 318 of the duplexer 320. The matching termination may be resistive as shown in FIG. 3, such as a 50 ohm resistive termination, or may include reactive components (not shown in FIG. 3) that provide 50 ohms of impedance. Other values of impedances may alternatively be used. The matching termination may be a termination that is specified by a manufacturer of the duplexer to optimize (maximize) the return loss of the receive portion of the filter at the antenna port 321 over the receive frequency band of the communication system in which the device 300 is to be used. It will be appreciated that with this novel configuration of the duplexer 320, the PA 310, and the matching termination 322, the antenna port 321 becomes one that provides optimal and stable tuning for the PA 310 for most combinations of the duplexer 320 and the PA 310 that are encountered in the manufacture of many (such as thousands or millions of) devices 300 employing this configuration. This added receive band filtering reduces the amount of noise in the transmitted signal that occurs within the receive frequency band in comparison to a design that uses only a transmit filter for a transmit only antenna.

The antenna system used in the device 300 is a simplex antenna configuration. A first receive antenna 352 intercepts downlink radio signals and couples them to a first receive matching network 335, which is designed to optimize the coupling of the first receive antenna 352 to the first receive filter 330 and, as described with reference to transmit matching filter 325, may be a passive network, a switched passive network, or may not be included. The first receive filter 330 rejects most of the energy of the radio signal outside the receive frequency band of the communication system. Alternatively stated, the first receive filter has a passband accommodates the receive frequency band of the communication system. The filtered signal 331 is coupled to other portions of the transmitter-receiver 120 of the device 300, which perform a receiving function using the filtered signal 331. It will be appreciated that the use of separate transmit and first receive antennas 351, 352 allows their physical configuration to be designed to optimize, respectively, the electrical matching of the transmit antenna 351 to the matching network 325 (or to the transmit port 319 of the duplexer when the matching network 325 is not used) and the electrical matching of the first receive antenna 352 to the first receive matching network 335, and also allows the gains of the transmit antenna 351 and the first receive antenna 352 to be increased in comparison to a prior art transmit-receive antenna of the same size, because both the antenna matching and antenna gains are over narrower frequency ranges than in prior art devices 100 as described above with reference to FIG. 2. It will be further appreciated that the use of separate transmit and receive antennas 351, 352 may allow for each antenna to be smaller than a transmit-receive antenna, such as transmit-receive antenna 230 described above with reference to FIG. 2., while still providing the same or greater gain than the transmit-receive antenna 230 because the separate antennas each accommodates only one of the two frequency ranges while the transmit-receive antenna must operates over both the transmit and receive frequency ranges and also over any frequency interval between the transmit and frequency ranges. The novel configuration of the duplexer in the embodiments described with reference to FIG. 3 enhances the benefits of simplex antennas, as further described below.

An additional benefit provided by the unique coupling of the PA 310 to the antenna port of the duplexer 320 is an increase of the receive antenna efficiency in comparison to a simplex antenna configuration that uses a transmit filter alone instead of the reverse duplexer configuration of these novel embodiments. For either configuration, the receive antenna efficiency of antenna 352 is determined by:

Efficiency (in %)=100*(1−10^{(-ISO/10)}*(1−10^{(-RL/10)})), (1)

wherein ISO is the antenna isolation in dB and RL is the return loss in dB at the coupling of the transmit antenna 351 to the duplexer transmit port 319. It will be appreciated that for a given antenna isolation, a lower return loss increases the efficiency. While this formula includes some idealistic assumptions, it will be appreciated that the general result is still true: a lower return loss increases the efficiency of the receive antenna 352. The transmit port 319 of the duplexer has a very low return loss over the receive frequency band because the transmit filter portion 324 is coupled to the optimally terminated receive filter portion 324. This allows most of the small amount of receive signal energy that passes the transmit filter portion 324 to be absorbed by the matching termination 322. The very low return loss is lower than that typically achieved for a separate transmit filter of comparable design. Therefore the receive antenna efficiency is better than that which would be achievable in a diversity system that uses a comparable transmit filter instead of a reverse coupled duplexer.

Another benefit provided by this novel configuration of the duplexer in FDD cellular systems is that duplexers having the necessary transmit and receive frequency ranges have been in use for some time and are very economical. They are less costly than transmit filters would be that have comparable specifications because of the present very high production quantities and long production history for the duplexer.

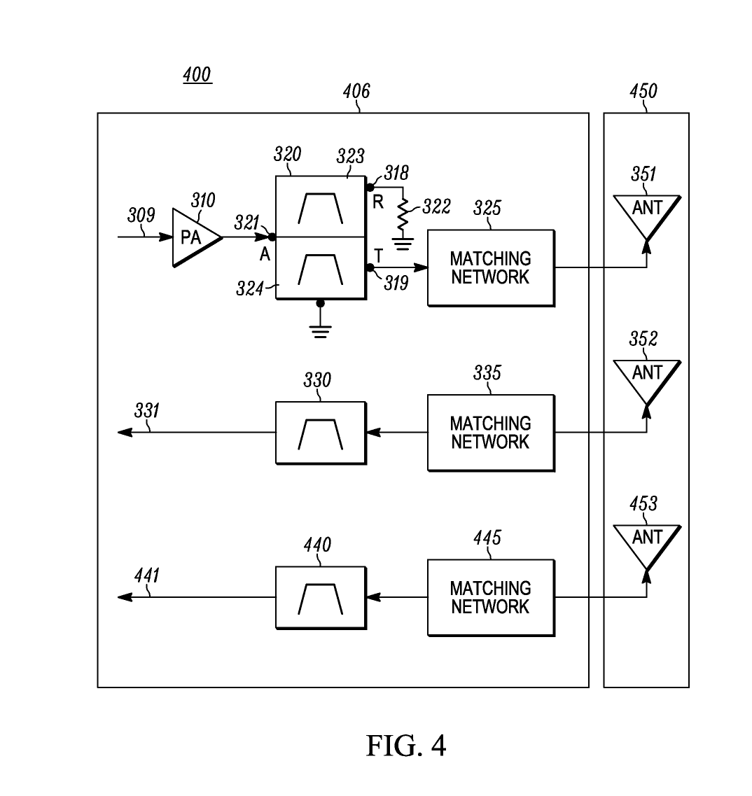

Referring to FIG. 4, an electrical block diagram of portions of a device 400 is shown, in accordance with certain embodiments in which the device 400 has novel features. The novel features are described with reference to FIG. 4 and function in conjunction with portions of device 400 that are substantially the same as the functions of device 100 (FIG. 1) that are not shown (e.g., processors 105, memory 110, and parts of receiver/transmitter 120) in FIG. 4. In particular, a duplexer 320 is coupled in a novel, reverse configuration. The device 400 incorporates the elements (signals and components) 305-352, except antenna system 350, described above with reference to FIG. 3, and in addition incorporates a diversity receive antenna 453 in an antenna system 450, and an optional diversity receive matching network 445 and a diversity receive filter 440 in a portion 406 of a device 400. The function of these elements is very much the same as the function of the same named elements 241-250 of FIG. 2. The antenna system 450 of the device 400 of FIG. 4 comprises antennas 351, 352, 453. The receive antenna efficiency of antenna 352 or 453 is determined by:

Efficiency (in %)=100*(1−10^{(-ISO/10}−10^{(-ISO/10)}*(1−10^{(-RL/10)})), (2)

wherein ISO is the antenna isolation in dB and RL is the return loss in dB at the coupling of the transmit antenna 351 to the duplexer transmit port 319. It will be appreciated that for a given antenna isolation, a lower return loss increases the efficiency. While this formula includes some idealistic assumptions, including that the ISO is the same for both receive antennas 352, 453, it will be appreciated that the general result is still true: a lower return loss increases the efficiency of the receive antenna 352 and diversity receive antenna 453. For the same reasons given above with reference to FIG. 3 the efficiencies of the receive antennas are better than those which would be achievable in a diversity system that uses a comparable transmit filter instead of a reverse coupled duplexer

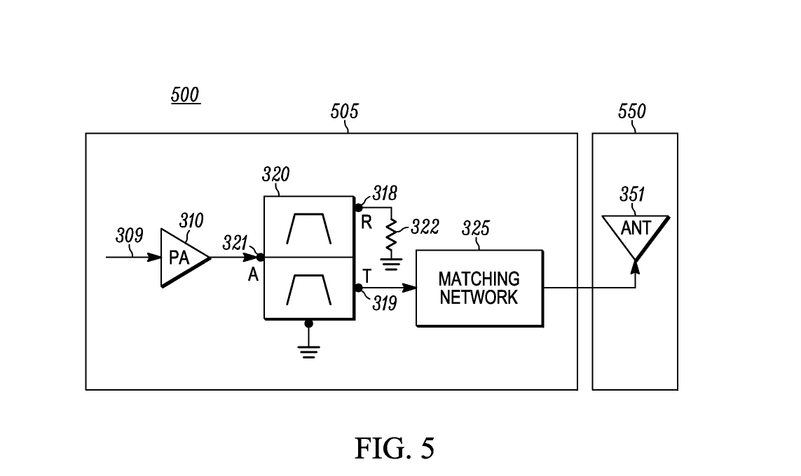

Referring to FIG. 5, an electrical block diagram of portions of a device 500 is shown, in accordance with certain embodiments in which the device 500 has novel features. The novel features described with reference to FIG. 5 function in conjunction with portions of device 500 that are substantially the same as the functions of device 100 (FIG. 1) that are not shown (e.g., processors 105, memory 110, and parts of receiver/transmitter 120) in FIG. 5. One exception to this is that the functions of device 100 related to receiving and processing received signals may be modified, deactivated or removed for device 500. The portion 505 and antenna system 550 of device 500 is the same as the portion 305 and antenna system 350 of device 300 described with reference to FIG. 3, except that device 500 does not have a receive chain, which comprised receive antenna 352, optional receive matching network 335, and receive filter 330 in device 300 (FIG. 3). The device 500 operates as a transmit only device. In a FDD communication system that is designed to accommodate transmit only devices, the device 500 provides at least the noise reduction benefit described with reference to the PA 310 output coupling at duplexer antenna port 321 and the cost benefits described above with reference to device 300 (FIG. 3). In a non-FDD communication system, the duplexer 320 may provide the cost benefits described above for non FDD communication systems that have a transmit frequency range within the range of a cellular FDD system.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising:
a duplexer having a transmit port, a receive port, and an antenna port;
a transmitter coupled to the antenna port of the duplexer; and
a transmit antenna coupled to the transmit port of the duplexer.

2. The apparatus according to claim 1, further comprising a matching termination coupled to the receiver port.

3. The apparatus according to claim 1, wherein the duplexer is a passive electrical device.

4. An apparatus for radio communications, comprising:
a duplexer having a transmit port, a receive port, and an antenna port;
a transmitter coupled to the antenna port of the duplexer;
a transmit antenna coupled to the transmit port of the duplexer; and
a first receive antenna coupled to a first receive filter.

5. The apparatus according to claim 4, further comprising a matching termination coupled to the receiver port.

6. The apparatus according to claim 4, wherein the duplexer is a passive electrical device.

7. The apparatus according to claim 4, wherein the first receive filter has a frequency passband that accommodates a receive frequency band of a radio communication system and the duplexer comprises a receive filter that has a passband that accommodates the frequency band of the communication system.

8. An apparatus for duplex radio communications, comprising:
a duplexer having a transmit port coupled to a transmit filter portion, a receive port coupled to a receive filter portion and an antenna port coupled to the transmit and receive filter portions, wherein the receive filter portion has a passband that accommodates receive frequency band of a communication system;
a transmitter coupled to the antenna port of the duplexer;
a transmit antenna coupled to the transmit port of the duplexer;
a first receive antenna coupled to a first receive filter that has a passband that accommodates the receive frequency band of the communication system; and
a second receive antennas, coupled to a second receive filter that has a passband that accommodates the receive frequency band of the communication system.

9. The apparatus according to claim 8, further comprising a matching termination coupled to the receiver port.

10. The apparatus according to claim 8, wherein the duplexer is a passive electrical device.

11. The apparatus according to claim 8, further comprising one or more additional receive antennas, each coupled to one of one or more respective additional receive filters.

12. The apparatus according to claim 8, wherein the additional receive antennas operate at a same receive frequency range as the first antenna receiver.

13. The apparatus according to claim 8, further comprising a transmit matching network that is coupled between the transmit antenna and the transmit port of the duplexer.

14. The apparatus according to claim 8, further comprising a receive matching network that is coupled between the first receive antenna and the first receiver.

15. The apparatus according to claim 8, wherein the duplexer has transmit and receive passbands at transmit and receive frequencies ranges specified for use in at one of LTE and CDMA cellular systems.
